(19) United States
(12) Patent Application Publication
(10) Pub. No.: US 2020/0175268 A1
(43) Pub. Date: Jun. 4, 2020

(54) SYSTEMS AND METHODS FOR EXTRACTING AND IMPLEMENTING DOCUMENT TEXT ACCORDING TO PREDETERMINED FORMATS

(71) Applicants: JAVIER H. LEWIS, CORAL SPRINGS, FL (US); UFUK C. DOGAN, NEW HAVEN, CT (US); MARK FLORY, OLATHE, KS (US)

(72) Inventors: JAVIER H. LEWIS, CORAL SPRINGS, FL (US); UFUK C. DOGAN, NEW HAVEN, CT (US); MARK FLORY, OLATHE, KS (US)

(21) Appl. No.: 16/696,438

(22) Filed: Nov. 26, 2019

Related U.S. Application Data
(60) Provisional application No. 62/771,400, filed on Nov. 26, 2018.

(51) Int. Cl. G06K 9/00; G06F 40/103; G06F 40/169; G06F 16/35; G06F 16/93; G06F 16/11; G06F 16/33; G06N 3/04; G06N 3/08

(52) U.S. Cl. CPC G06K 9/00463; G06K 9/00456; G06F 40/103; G06F 40/169; G06K 9/00483; G06K 2209/27; G06F 16/93; G06F 16/116; G06F 16/334; G06N 3/0454; G06N 3/088; G06F 16/353

(57) ABSTRACT

A system and method used herein may extract information from a PDF file using spatial layout processing techniques through the use of training data disposed to convert a PDF file into a raw format file. Said raw format file may comprise a raw binary file disposed to create an image wherein contiguous text blocks are classified according to the data disposed therein and identified according to an individually colored block of image pixels. Accordingly, comparison of a collection of raw format files with a given PDF file may allow for the efficient and accurate extraction of syntactic and image data from said PDF file for use in a text editor application.

### CLAIM OF PRIORITY

The present application is a non-provisional patent application which claims priority pursuant to 35 U.S.C. Section 119(e) to a currently pending and prior filed provisional patent application, namely, that having Ser. No. 62/771,400 filed on Nov. 26, 2018, the contents of which is incorporated herein by reference in its entirety.

### BACKGROUND OF THE INVENTION

### Field of the Invention

The present disclosure is directed to systems and methods for extracting and implementing document text into a text editor application according to predetermined formats using image processing techniques embedded in an encoder-decoder architecture.

### Description of the Related Art

There exists a vast amount of research on the Internet locked inside PDF format. From preprints to peer-reviewed literature and historical research, millions of scientific manuscripts today can only be found in a print-era format that is effectively inaccessible to the web of interconnected online services increasingly disposed at the forefront of today's research infrastructure. Moreover, the rapid growth of the volume of scholarly publications makes it increasingly difficult to manage collections of scientific literature and assess the quality of output. Because the most common format for said scholarly articles is PDF, and because PDF format is optimized for presentation but ultimately lacks sufficient structural information for effective use within typical processing systems, there exists a need for automated processing systems disposed to semantically enrich documents with information in support of relevant tasks, such as management of collections and assessment of the quality of output.

Previous efforts have developed tools, such as metadata extraction, document summarization, and keyword extraction, for more effectively managing information disposed within a PDF file. Such efforts have produced systems for extracting information disposed within a PDF file and expressing said information in an XML file. Other efforts have produced keyword databases and models for extracting said keywords from a PDF file. Likewise, systems have been produced which may split each piece of information disposed within a PDF file into a block, wherein each block is analyzed according to the block's syntactic attributes.

As may be understood, each of the aforementioned methods and systems have various problems and inefficiencies associated with them, particularly when said methods are employed in a system designed to effectively assess information for the voluminous amount of documents currently available. For instance, each of the aforementioned methods and systems have a focus on the individual elements of the PDF file. More specifically, each of the aforementioned methods and systems employs techniques designed to extract information from a PDF in a piecemeal, front-end oriented fashion by focusing on the actual information, keywords disposed within said information, or the syntactic attributes of blocks of information. Accordingly, in so doing, each of the aforementioned methods and systems often meet problems associated with efficiency. Likewise, particular methods and systems, such as those employing keyword extraction or syntactic analysis, may meet problems of inaccuracy resulting from ambiguity of terms and various syntactic issues resulting from the lack of sufficient structural information disposed within a PDF file.

Although managing collections of scientific literature and assessing the quality of output for the development of scientific articles, journal, or papers may not be particularly difficult for experts, those knowledgeable in the field, or experienced scientific researchers, it may prove overwhelming for those lacking such experience, such as students. Such difficulties may stem from a variety of problems, such as misremembering documents already assessed and properly referencing said documents in their own work. Moreover, when confronted with such difficulties, such inexperienced authors may often become frustrated, leading to a lower quality work product. Furthermore, given the constraints associated with the aforementioned methods and systems for effectively assessing the information disposed within a PDF document, there does not exist a current method for effectively assisting such inexperienced authors in an effective and accurate manner.

Accordingly, there exists a need for a method and system designed to effectively and efficiently assist authors, users, and the like in extracting and evaluating information disposed in files, such as PDF files. Such a method and system must be both efficient and accurate when employed at a scale sufficient to provide adequate research in accordance with the volume of scientific articles both currently available and as may become available in the future. Moreover, such a method and system should seek to ease the burden on inexperienced authors by automatically assessing such files and developing appropriate information, such as citation and/or reference information, for the easy management of such files and the information disposed therein. More specifically, there is a need for an automated processing system which may semantically enrich documents with information in support of the aforementioned goals.

Finally, such a proposed method and system may be disposed within an application, such as a text editor, which may seek to include additional functionality to further assist inexperienced authors in drafting research papers and other technical documents. For instance, such additional functionality may include an automatic searching feature, whereby existing databases are automatically searched in real time for further files containing relevant information according to the textual input of a user of such an application. Likewise, such an application may include a feature allowing for collaborative writing between users, thereby allowing multiple users to perform research and draft and/or edit such a research paper and/or technical document.

### SUMMARY OF THE INVENTION

Some or all of the above needs and/or problems may be addressed by various embodiments of the disclosure. Certain embodiments may include systems and methods pertaining to a text editor application designed to make the creation of research papers, scientific articles, and the like much simpler to create by extracting and implementing document text into said text editor application using image processing techniques embedded in an encoder-decoder architecture. Likewise, certain embodiments may further provide for such a text editor application to employ additional functionality such as the real-time searching of existing databases for additional files containing relevant information and collaborative writing between a plurality of users.

A text editor is a computer program which allows a user to enter, change, store, and usually print text, which may comprise, for instance, characters and numbers, each encoded by the computer and its input and output devices and arranged in such a way so as to have meaning to users or other programs. Accordingly, a text editor provides an “empty” display screen (or “scrollable page”) with a fixed-line length and visible line numbers. Using said scrollable page, a user may create a document through the input of text, line by line, and may perform various other operations such as formatting the document for output to a specific device or class of devices. Subsequently, the user may save the document for printing or display.

Correspondingly, a text editor in accordance with at least one embodiment of the present invention may do all of the aforementioned tasks. More specifically, such a text editor may allow for document creation while simultaneously providing for the easy and efficient creation of research papers, scientific articles, and the like through a back end system designed to support the scientific process via a research component disposed to automatically find relevant documents and form citations thereof. Furthermore, in at least one embodiment, a text editor in accordance with the present invention may be disposed to facilitate the collaborative writing of such documents, by enabling the sharing and tracking of information between a plurality of users.

As may be understood, at least one embodiment of the present invention is focused on referencing other research papers as a user drafts his or her paper. Likewise, at least one embodiment of the present invention is focused on returning figures for a user to utilize in his or her research paper. Accordingly, the method and system disclosed herein may use a trained model to extract relevant information out of a selected file.

As previously stated, the bulk of scientific research, including preprints and peer-reviewed literature and historical research, is disposed in a PDF format. Accordingly, a text editor in accordance with at least one embodiment of the present invention must be disposed with a back end system designed to effectively manage and assess the information disposed within said PDF files. More specifically, such a text editor should be able to efficiently and accurately extract relevant information, such as key information, and figures from a PDF file for the easy disposition within a document created in said text editor.

However, extraction of relevant information from a PDF file is not trivial due to the previously mentioned lack of structural information disposed therein. For instance, PDF files typically only contain information pertaining to individual characters and their position on the page. Moreover, such information is generally noisy, comprising additional and/or redundant information making the interpretation thereof more difficult. Accordingly, as may be understood, the parsing and extraction of text based on things such as words, paragraphs, and metadata disposed within PDF files often is laborious and unreliable, at least in part because PDF files contain principally four basic components:
1) Tokens (e.g., text elements specifying characters drawn at certain positions);
2) Font glyphs;
3) Images; and
4) Paths.

As may be understood, due to the lack of structural information disclosed within any given PDF file, the goal of the aforementioned method is to focus on relevant areas of the PDF file as opposed to the individual elements disposed throughout the PDF file. More specifically, the focus is on the image of the file and the location of the relevant portions of text as opposed to the textual elements themselves. Accordingly, in at least one embodiment, such a method may seek to employ spatial layout processing techniques comprising at least semantic segmentation to identify and annotate specific regions of a PDF file containing key information, such as the title of the document or the authors.

As generally understood, semantic segmentation refers to a process linking each pixel in an image to a class label in order to simplify and/or change the representation of an image into something more meaningful and easier to analyze. Accordingly, semantic segmentation has a wide array of applications, ranging from scene understanding, inferring support-relationships among objections, and autonomous driving. Typically, as semantic segmentation is primarily motivated by road scene understanding applications, such applications are used to apply the majority of pixels in an image to large classes, such as a road or a building.

However, as used herein, semantic segmentation techniques may instead be used to identify specific areas of a PDF file containing key information, such as the title or authors. Such specific areas, herein referred to as “text blocks,” may then be classified and annotated with a separate tag indicating the type of key information classified therein. Subsequently, the annotated text blocks may be converted to colored blocks with each colored block representing a separate tag. Finally, the information therein disclosed may be output to something easier to analyze, such as a PNG file.

Accordingly, in at least one embodiment of the present invention, a method for extracting and implementing document text into said text editor application includes: (1) adding a document into the text editor application; and (2) analyzing said document to determine an output comprising, for instance, a citation of said document or any figures disposed therein, to a user of the text editor application, wherein, said analyzing of said document comprises reference to a database composed of raw format files. As may be understood, said database may be formed by a method for training a back-end encoder-decoder architecture including: (a) assembling a collection of PDF files paired with corresponding XML files; (b) detecting contiguous text blocks using spatial layout processing techniques; (c) classifying said contiguous text blocks into categories; and (d) converting the classified text blocks into a raw format, such as individually colored image pixels. Each of the steps associated with said methods will be briefly discussed herein.

As may be understood, implementation of the aforementioned training method is not an easy task due to the myriad variations in font, layout, and content disposed within PDFs from different sources. Accordingly, a system employing such a method requires training of the encoder-decoder architecture to ensure the accuracy of the detection and subsequent classification of contiguous text blocks. As previously mentioned, such training may comprise, for example, the collection of a wide variety of PDFs and their corresponding XML, to determine the particular locations of specific key information for any given PDF.

More specifically, as may be understood, by collecting such a wide variety of PDFs, said myriad of variations in font, layout, and content may be catalogued in a manner enabling the encoder-decoder architecture to accurately detect and classify the relevant contiguous text blocks. In doing so, particular PDF files containing associated XML data may first be collected. As may be understood, the associated XML files contain the metadata associated with the particular PDF file. Such metadata may comprise information such as, for example, the title, author(s), abstract, paragraphs, tables, and formulas disposed within the text.

Accordingly, in at least one embodiment of the present invention, a method for training a back-end encoder-decoder architecture may first detect contiguous text blocks disposed within a PDF file may be detected according to spatial layout processing techniques, namely semantic segmentation. Accordingly, upon selection of a particular file, an encoder-decoder architecture or network may detect particular regions of said file containing text blocks comprising key information, such as information relevant to a citation, including, without limitation, the title of the document and the author(s). Such identification may depend upon the associated metadata disclosed within the XML data associated with a given PDF file.

Subsequent to said detection, the encoder-decoder architecture may then classify said text blocks into categories using the metadata disclosed within the XML data associated with a given PDF file. Such classification may, for instance, comprise class labels, such as tags, meant to identify the specific key information disposed within a given text block. For instance, in the case of key information pertaining to the citation information for a given file, one tag may be used to classify a text block as containing the title, while another distinct tag may be used to classify a text block as containing the author(s).

Once each text block has been classified, the encoder-decoder architecture may then convert the PDF file into a raw format. In at least one embodiment of the present invention, such a raw format may comprise a PNG file wherein each annotated text block is converted to a distinct colored block where each color represents a different tag. As may be understood, when disposed in said raw format, said text blocks, and the information disposed therein, may be more efficiently processed to determine an appropriate output.

Finally, the raw format may be used to train the encoder-decoder architecture. For example, a given raw format may be stored within a database and disposed to be referenced upon additional applications of the aforementioned training method. For example, said raw format may be processed by a pipeline for the determination of a given output. Such an output may comprise, for example, a citation for a reference wherein said citation output may be dependent upon predetermined citation format. In such an instance, as may be understood, the information disclosed within each annotated text block may be extracted and duly placed in said citation according to the text block's classification. Likewise, any images disposed within a given file may be extracted for the insertion into the text editor application by a user.

Next, upon adequate training of the encoder-decoder architecture, the aforementioned extraction method may be applied such that contiguous text blocks are detected and classified according to a comparison with the raw formats disposed within the database of the encoder-decoder architecture. Then, such text blocks may be stitched together in a predetermined order resulting in the extraction of text from section-wise grouped blocks for an output comprising, for instance, a citation of said document or any figures disposed therein, to a user of the text editor application and used to train the encoder-decoder network.

Thus, as may be understood, the encoder-decoder network may be trained to accurately identify and classify contiguous text blocks according to the appearance of a given PDF for the extraction of the data disclosed therein. Accordingly, reliance on the actual syntactic elements disposed within a PDF file may be reduced and/or eliminated. Moreover, as the initial training of the encoder-decoder architecture may happen prior to the use of the text editor application, the efficiency of such extraction may be enhanced.

Of course, there remains a possibility such training may not be completely accurate. For instance, there remains a possibility a detected contiguous text block is wrongly classified. Alternatively, it is possible a given contiguous text block may contain unnecessary textual characters or elements. Accordingly, as may be understood, when such event arises, a user may edit the output returned by the aforementioned method in which case the encoder-decoder network will log such data in the database in connection with further training.

In further embodiments of the invention, additional functionality may be disposed within the text editor, and possibly employed in connection with the aforementioned method, to further assist inexperienced authors in drafting research papers and the like. For instance, in at least one embodiment, a research component may be disposed to conduct research in real time and in accordance with the input of a user, which may include the textual input and/or particular references cited by the user.

More specifically, such a research component may be disposed to derive search data according to the textual input and/or referenced cited by the user of the text editor application. Such search data may comprise, for instance, pertinent keywords found throughout the document. Likewise, said search data may comprise common keywords found throughout the references cited within the document. Moreover, said search data may comprise information relevant to the last cited reference or textual input.

Accordingly, upon said derivation of the search data, the research component may search at least one established database for additional files and/or references containing said search data. In such a manner, the research component may operate in the background of the text editor application while automatically performing relevant searches pertaining to the search data and may store any found files and/or references for later review by the user. Likewise, any reference currently cited by the user may also by searched for information pertaining to said search data.

Furthermore, in at least one embodiment of the present invention, the text editor application may be disposed for collaborative writing amongst a plurality of users. In such an embodiment, the text editor application may allow for a plurality of users to simultaneously access a given document and perform a variety of functions within said document at the same time. Such functions may include, for instance, research, editing, messaging amongst one another, and reviewing the work of other collaborators.

In yet further embodiments, additional functionalities may be disposed within the text editor designed to assist in the drafting of a research document. Such additional functional modules may include, without limitation: (1) a statistical module disposed to assess various statistical quantities associated with the user's document, such as plagiarism risk, active voice, and reading level; (2) the automatic tracking of documentation and citation use; and (3) deployment of the text editor application on a cloud-based system.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a flow diagram of an embodiment of a text editor application incorporating various aspects of the present invention.

FIG. 2 is a flow diagram of one embodiment of the present invention comprising a method for training an encoder-decoder architecture.

FIG. 3 is an exemplary diagram depicting one embodiment of a raw format produced by the method of FIG. 2.

FIG. 4 is a flow diagram depicting a method for extracting syntactic and/or image information disposed within a PDF file, in accordance with one embodiment of the present invention.

FIG. 5 is a flow diagram depicting an additional embodiment disposed to provide further training in accordance with the embodiment depicted in FIGS. 2 and 4.

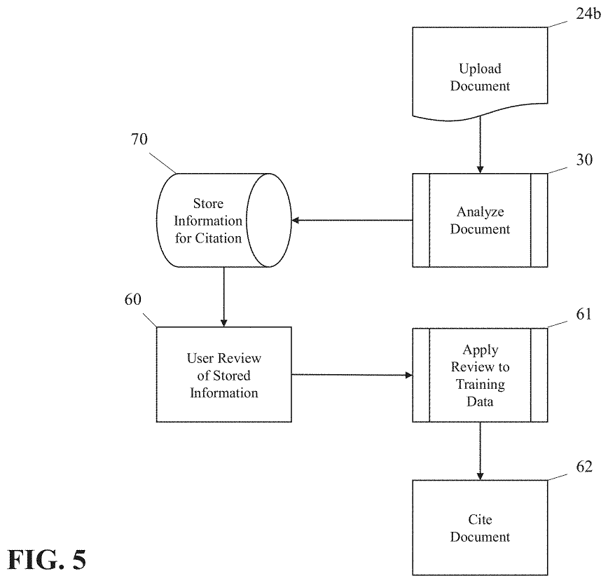

FIG. 6 is a flow diagram depicting an exemplary pipeline to be used in conjunction with an encoder-decoder architecture, in accordance with one embodiment of the present invention

FIG. 7 is a flow diagram depicting a research component, in accordance with one embodiment of the present invention.

FIG. 8 is a flow diagram depicting a collaboration component, in accordance with one embodiment of the present invention.

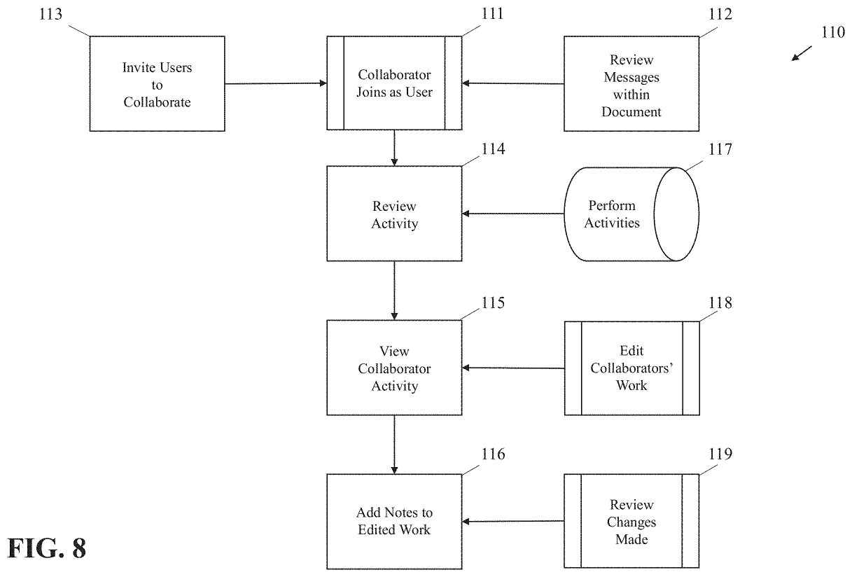

Like reference numerals refer to like parts throughout the several views of the drawings.

### DETAILED DESCRIPTION OF THE PREFERRED EMBODIMENT

Illustrative embodiments of the disclosure will now be described more fully hereinafter with reference to the accompanying drawings in which some, but not all, embodiments of the disclosure are shown. The disclosure may be embodied in many different forms and should not be construed as limited to the embodiments set forth herein; rather, these embodiments are provided so this disclosure will satisfy applicable legal requirements.

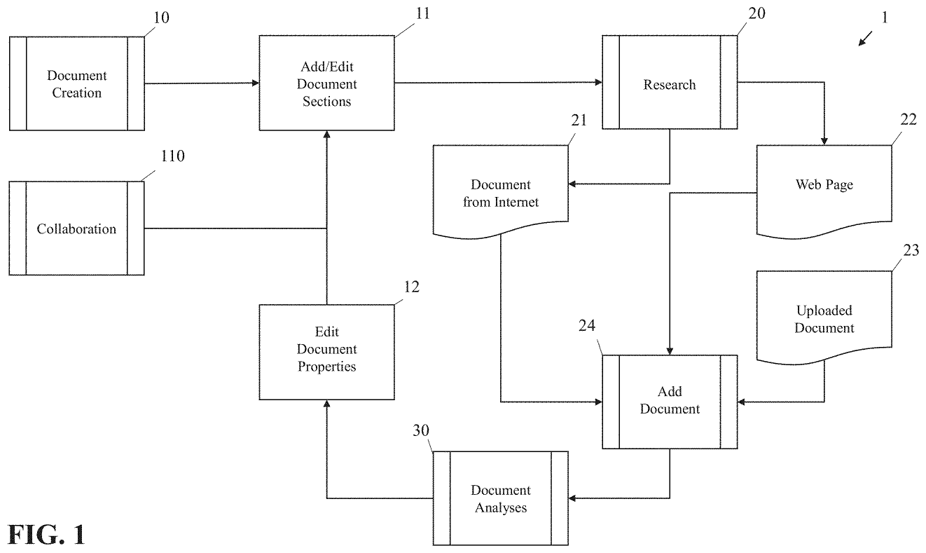

As shown in FIG. 1, depicted therein is a flow diagram for a text editor application 10 in accordance with one embodiment of the present invention. As may be seen, within such a text editor application 10, a user may create a document 10 and subsequently add or edit document sections 11 through the input of textual elements in a line-by-line format. Further, disposed within the text editor may be a research component 20 which may provide a variety of capabilities, such as performing research. Such research may comprise, for example, documents from the internet 21, which, as stated previously typically may constitute a PDF, web pages 22, and documents uploaded by the user 23. Subsequently, such research may be added into the text editor system for subsequent document analyses 30, which may include, for instance, the automatic generation of a reference cite and/or extraction of images depicted therein. Further, such a text editor application 10 may allow for the editing of document properties 12, such as, for example, the citation style used, the properties of the various textual elements, or even the layout of any windows or screens depicted within the text editor system. Additionally, as stated previously, such a text editor application 10 may provide for collaboration 110 amongst a plurality of users, such that said plurality of users may simultaneously access a document and perform any of the aforementioned tasks.

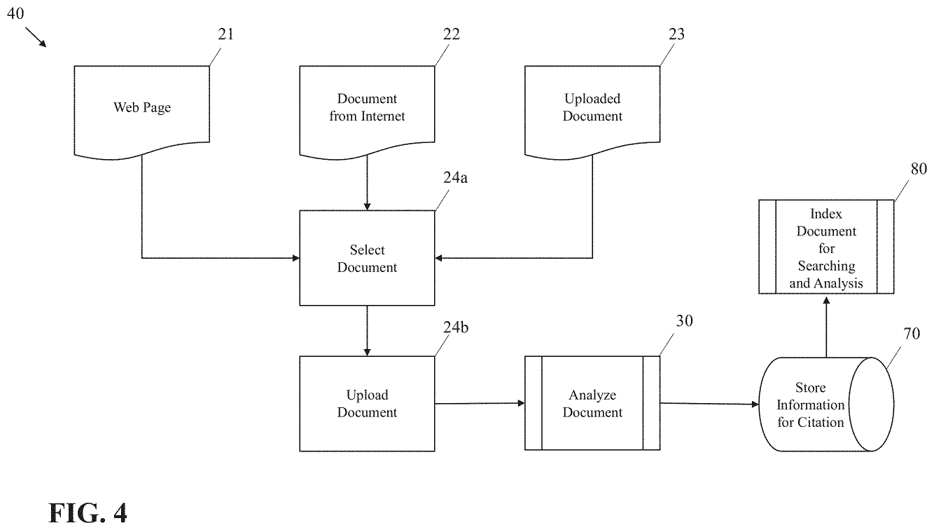

With reference to FIG. 4, depicted therein is a flow diagram showing a functionality of the extraction method 40 in accordance with at least one embodiment of the present invention. Such an extraction method 40, as previously stated, may utilize documents from the internet 21, which, as stated previously typically may constitute a PDF, web pages 22, and documents uploaded by the user 23, each of which may be selected by a user 24a and subsequently uploaded into the text editor 24b. Such documents may then be analyzed 30 for the extraction of pertinent information, such as key data and figures, and may finally be indexed 60 for later searching and document analysis. Moreover, such indexing 60 may be utilized in tracking references to each document throughout a research paper, thereby effectively organizing such references for the user(s). Further, indexing 60 may further comprise applying the document to the training method 50, as will be discussed herein, for additional training of the back-end encoder-decoder system.

Once the relevant document(s) have been selected 24a and uploaded 24b into the text editor application 10, the application may then analyze the document 30 for the extraction of pertinent information, such as key data and figures. As stated previously, because many of the relevant documents which may be selected for use within a research paper may be disposed within a PDF file, and because it is often difficult to extract syntactic information from a PDF file due to the lack of structural information, particular training, comprising certain analyses, need be applied to a back-end encoder-decoder architecture for the effective extraction of such pertinent data. Such analyses 30 may comprise spatial layout processing techniques, such as semantic segmentation, for the efficient and accurate detection and extraction of such pertinent information.

Thus the analyzation of the document 30 may comprise detecting contiguous text detecting contiguous text blocks disposed within a file using spatial layout processing, classifying the text blocks into categories, stitching classified text blocks together in a predetermined order resulting in the extraction of text from section-wise grouped blocks, and returning at least one reference to a user of the text editor application 10.

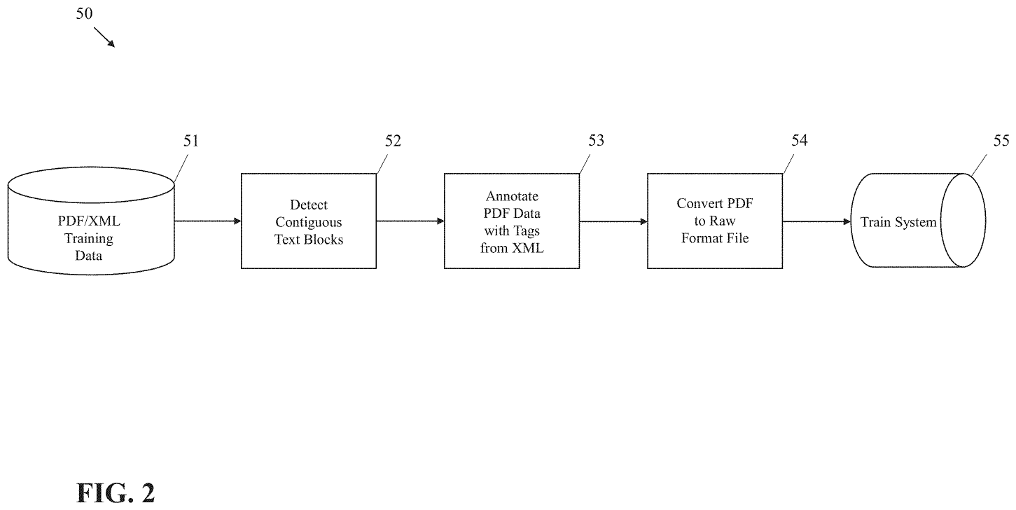

As stated previously, such spatial layout processing techniques, especially semantic segmentation, aim to identify and classify specific areas of a PDF file which may contain pertinent information, including key data, such as, for instance, the title of the document or the author(s). Accordingly, a training method 50 in accordance with at least one embodiment of the present invention for performing such spatial layout processing techniques to train the encoder-decoder architecture for use in analyzing a document 30 may be seen with reference to FIG. 2.

Moreover, as previously mentioned, at least the steps comprising the use of spatial layout processing techniques may utilize an encoder-decoder architecture or network to efficiently map raw image pixels to a representation of a collection of feature vectors and subsequently produce an output mapped into a raw format. Further, said encoder-decoder architecture may further comprise, for instance, a convolutional neural network (“CNN”) which may process and extract, using training data, the syntactic and image data disposed within the PDF files according to an input and output layer, in addition to hidden layers which may comprise convolutional layers, pooling layers, fully connected layers, and normalization layers. Accordingly, the conjunctive use of an encoder-decoder architecture and a convolutional neural network may increase the accuracy of said spatial layout processing techniques. Thus, in at least one embodiment of the present invention a SegNet CNN may be employed, however, as may be understood, alternative embodiments may exist comprising alternative encoder-decoder architecture designed to efficiently and accurately detect and extract the syntactic elements disposed within a PDF file. For instance, in additional embodiments, a LSTM network may be effectively employed to perform the aforementioned tasks and techniques. Further, in some embodiments, a protocol buffer may be disposed within the encoder-decoder architecture to serialize structured data in an efficient way, thereby increasing the efficiency of said encoder-decoder architecture.

In at least one embodiment, a training method as depicted in FIG. 2 may be employed wherein an encoder-decoder architecture may analyze a PDF document and the associated XML data 51 by first utilizing said spatial layout processing techniques, such as semantic segmentation, to detect contiguous text blocks 52 disposed within the PDF file. Said contiguous text blocks may comprise, for instance, key information or images disposed within the PDF file. Further, such contiguous text blocks may comprise, in at least some embodiments, a block profile. The block profile associated with each individual text block may be defined as the threshold vertical or horizontal projection of the area within the text block, wherein the block profile corresponds to the information extending across the entire block. More specifically, the block profile may comprise a binary string containing a zero for each horizontal or vertical scanline containing a white pixel and a one for the remaining non-white pixels. Accordingly, by defining a given contiguous text block according to a block profile, subdivisions of each contiguous text block may be identified so each detected contiguous text block comprises the entire information meant to be disclosed therein. Further, as may be understood, such application may also serve to identify each portion of syntactic or image elements disclosed within a PDF file.

Next, the encoder-decoder architecture may classify each of said detected contiguous text blocks 53. The goal of this step is to categorize each contiguous text block according to the information disposed therein. For instance, one contiguous text block may be classified as containing the title information; another contiguous text block may be classified as containing the author(s) information; and another contiguous text block may be classified as an image disposed within the PDF file. Accordingly, each contiguous text block may be annotated 53 with a label, such as a tag, meant to identify the particular type of information associated with said contiguous text block.

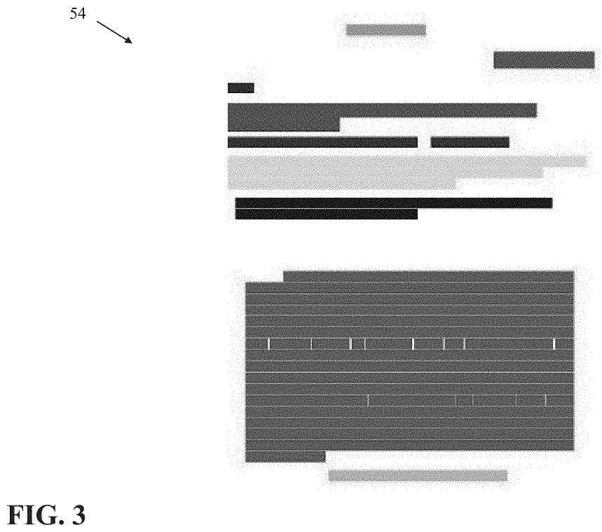

Subsequently, the encoder-decoder architecture may convert the contiguous text blocks and associated tags into a raw format 54. In some embodiments, the raw format may comprise, for example, an annotated image where each contiguous text block is outlined, or otherwise identified with, a distinct color. Such annotated image may comprise, for instance, a PNG file or any other like file which may be more efficiently processed to determine the appropriate output. For example, FIG. 3 depicts an example of the raw format 54 of a PDF file wherein the contiguous text blocks are represented according to distinct colored blocks disposed within a PNG file.

With further reference to FIG. 2, after the conversion of the PDF file to a raw format 54, a pipeline, which may be utilized to increase the efficiency of the method, may train the encoder-decoder architecture. Such training may comprise, for instance, storing the raw format file in a database disposed within the encoder-decoder architecture. Accordingly, as may be understood, as additional raw format files are input into said encoder-decoder architecture, additional information may be utilized in determining an output, during the extraction method, for return to a user of the text editor application 10. Such an output may comprise, for example, a citation for a reference wherein said citation output may be dependent upon a predetermined citation format. In such an instance, as may be understood, the information disclosed within each annotated text block may be extracted and duly placed in said reference citation according to the classification associated with each annotated text block. Likewise, any image disposed within a given file may be extracted for the insertion into the text editor application 10 by a user.

As may be understood, an embodiment employing the method disclosed in FIGS. 2 and 4 in connection with an encoder-decoder architecture utilizing a convolutional neural net may require training to achieve the requisite accuracy due to the myriad variations in font, layout, and content disposed within PDF files from different sources.

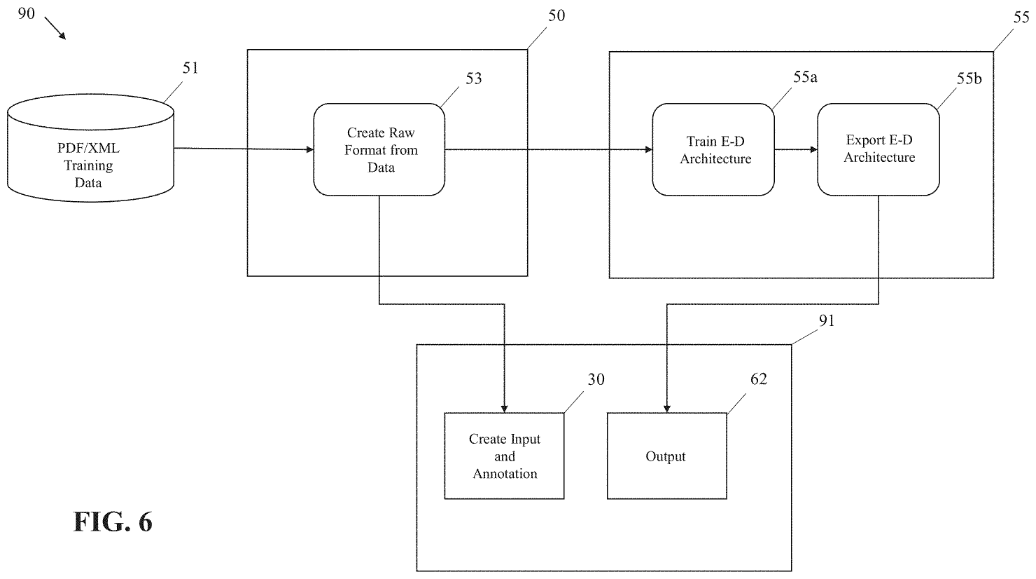

As may be understood, there remains a possibility such training method 50 may not result in a completely accurate output when used in connection with the extraction method 40. For instance, there remains a possibility a detected contiguous text block is wrongly classified. Alternatively, it is possible a given contiguous text block may contain unnecessary textual characters or elements. Accordingly, as may be understood, when such event arises, a user may edit the output returned by the aforementioned method in which case the encoder-decoder network will log such data in connection with further training in accordance with the embodiment depicted in FIG. 6.

Specifically, subsequent to the training of the encoder-decoder architecture and the storing of the information for a particular citation 70, a user of the text editor application 10 may review the stored information 70. In so doing, a user may identify and correct any issues associated with the stored information such as, for instance, those identified above. Accordingly, subsequent to said review, the associated review information may be applied to the training data. As may be understood, said review information may comprise any corrections made by the user, or may comprise no corrections and the affirmation of accurate stored information 70. Finally, a citation may be generated 62 for the relevant document.

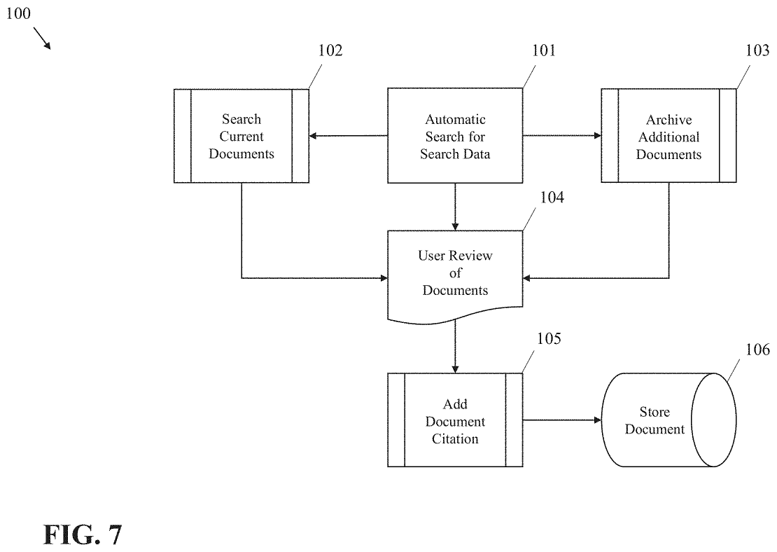

As previously mentioned, a pipeline 90 may be utilized for the efficient processing of the raw data and determination of an appropriate output. As may be seen in FIG. 7, depicted therein is a pipeline 90 which be utilized in accordance with one embodiment of the present invention. As may be seen, the training method 50 for extracting information from a PDF file and importing said information into a document disposed within a text editor application 10 may be used to render an output 91. Accordingly, the aforementioned training method 50 may be stored and executed in an orderly manner thereby increasing the efficiency of the text editor application 10 employing such training method 50 for use in conjunction with the extraction method 40.

As previously stated, in additional embodiments of the invention, additional functionality may be disposed within the text editor and possibly employed in connection with the aforementioned method to further assist inexperienced authors in drafting research papers and the like. For instance, as may be seen with reference to FIG. 7, one such embodiment may comprise a research component 100 disposed to conduct research in real time and in accordance with the input of a user, which may include the textual input and/or particular references cited by the user.

More specifically, and with reference to FIG. 7, such a research component 100 may comprise automatically searching for search data 101 within current documents 102 and additional documents 103. As may be understood, said current documents 102 may include the references cited by the user in the text editor application 10. Likewise, said additional documents 103 may comprise documents disposed within an established search database. Such research component may search for keywords comprising, for instance, a keyword input of the user or relevant keywords associated with the references cited by the user in the text editor application 10.

Subsequent to said automatic searching 101, the user may then review the additional documents 104 for determination of the relevancy of said additional documents. Accordingly, the user may select those documents the user wishes to include in the text editor application 10. Subsequently, a citation for the document 105 will be formed in accordance with the extraction method 40 disclosed herein. Finally, the document may be stored 106 for additional reference by the user.

Likewise, in at least one further embodiment of the present invention, a collaborative writing module 110 may be disposed within the text editor application 10, thus allowing for the simultaneous access of the document by a plurality of users. As may be seen, such a collaborative writing module 110 may allow a plurality of users to perform a variety of different tasks, including, but not limited to, review of activity 114, editing of the collaborators' work 118, adding notes to edited work 116, and messaging between collaborators 112.

Furthermore, additional embodiments may employ additional functional modules for assisting the user in drafting research papers and the like. Such additional functional modules may include, without limitation: (1) a statistical module disposed to assess various statistical quantities associated with the user's document, such as plagiarism risk, active voice, and reading level; (2) the automatic tracking of documentation and citation use; and (3) deployment of the text editor application 10 on a cloud-based system.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for importing information into a document comprising:
detecting contiguous text blocks disposed within a file using spatial layout processing;
classifying the text blocks into categories;
stitching classified text blocks together in a predetermined order resulting in the extraction of text from section-wise grouped blocks; and
returning at least one reference to a user of the method.

2. The method of claim 1, wherein the at least one reference returned to the user of the method comprises a predetermined format.

3. The method of claim 1, wherein each contiguous text block corresponds to a block profile.

4. The method of claim 3, wherein each contiguous text block further corresponds to key information.

5. The method of claim 1, wherein a raw format file created during training of an encoder-decoder architecture is utilized to detect the contiguous text blocks disposed within the file.

6. The method of claim 1, further returning at least one figure to a user of the method.

7. The method of claim 1, wherein the user of the method comprises one of a plurality of users of the method.

8. The method of claim 1, further structured to index the file and the associated output for additional searching and analysis.

9. A program for importing information into a document, wherein the program includes instructions embedded in a computer readable medium capable of causing a computer to perform:
detecting contiguous text blocks using spatial layout processing;
classifying said text blocks into categories;
stitching classified text blocks together in a predetermined order resulting in the extraction of text from section-wise grouped blocks; and
returning at least one reference to a user of the program.

10. The program of claim 9, wherein said instructions further comprise returning at least one figure to said user of the program.

11. The program of claim 9, wherein a raw format file created during the training of an encoder-decoder architecture is utilized to detect said contiguous text blocks.

12. The program of claim 11, wherein the raw format file comprises individually colored image pixels.

13. The program of claim 9, wherein each contiguous text block corresponds to a block profile associated with key information.

14. The program of claim 9, wherein said program includes further instructions embedded in a computer readable medium capable of causing a computer to perform:
deriving search information according to a least the textual input of said user of the program; and
searching at least one existing database for additional files containing said search information.

15. A system for extracting information from a file, said system comprising:
a computer;
a memory device accessible by the computer;
an application program loaded onto the memory device, the application program comprising:
an encoder-decoder architecture disposed to detect contiguous text blocks within a file according to the associated metadata;
said encoder-decoder architecture further disposed to classify said text blocks into categories according to the associated metadata; and
said encoder-decoder architecture further disposed to convert said classified text blocks into a raw format file.

16. The system of claim 15, wherein said application program further comprises a pipeline disposed to process said raw format file for the extraction of text from a document according to spatial layout processing.

17. The system of claim 15, wherein said application program further comprises a protocol buffer for serializing the contiguous text blocks in conjunction with encoder-decoder architecture.

18. The system of claim 15, wherein said raw format file comprises individually colored image pixels.

19. The system of claim 15, wherein said application program is further disposed to:
derive search data according to at least the textual input from at least one user of the computer text editor program; and
search at least one established database for additional files containing said search data.

20. A method for training an encoder-decoder architecture to detect and classify contiguous text blocks disposed within a file, the method comprising:
assembling a file and associated metadata;
classifying a plurality of text blocks in the file according to the associated metadata;
annotating each of the text blocks in the file;
converting the annotated file to a raw format file, said raw format file comprising individually colored image pixels corresponding to each of the annotated text blocks; and
storing the raw format file in a database for later comparison.

21. The method of claim 20, wherein each annotated text block corresponds to a block profile associated with key information.

22. The method of claim 20, wherein the stored raw format file is compared with at least one document for the extraction of data therefrom.
